(19) United States
(12) Patent Application Publication
(10) Pub. No.: US 2009/0096927 A1
(43) Pub. Date: Apr. 16, 2009

(54) SYSTEM AND METHOD FOR VIDEO CODING USING VARIABLE COMPRESSION AND OBJECT MOTION TRACKING

(76) Inventors: William O. Camp, JR., Chapel Hill, NC (US); Mark G. Kokes, Raleigh, NC (US); Toby J. Bowen, Durham, NC (US); Walter M. Marcinkiewicz, Chapel Hill, NC (US)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(21) Appl. No.: 11/925,196

(22) Filed: Oct. 26, 2007

Related U.S. Application Data
(60) Provisional application No. 60/980,011, filed on Oct. 15, 2007.

(51) Int. Cl. H04N 5/00

(52) U.S. Cl. 348/613

(57) ABSTRACT

A video coding technique and system employ variable compression for different portions of an imaged scene and motion tracking of an object. The object is coded to have higher fidelity than a remainder of the scene. The higher fidelity facilitates tracking of the object that, in turn, assists in maintaining quality coding of the object.

### RELATED APPLICATION DATA

This application claims the benefit of U.S. Provisional Patent Application Ser. No. 60/980,011 filed Oct. 15, 2007, the disclosure of which is herein incorporated by reference in its entirety.

### TECHNICAL FIELD OF THE INVENTION

The technology of the present disclosure relates generally to compression of video data and, more particularly, to a system and method for video coding using different amounts of compression for various portions of a video image and tracking a moving object that is compressed to have high image fidelity.

### BACKGROUND

Mobile and/or wireless electronic devices are becoming increasingly popular. For example, mobile telephones, portable media players and portable gaming devices are now in wide-spread use. In addition, the features associated with certain types of electronic devices have become increasingly diverse. For example, many mobile telephones now include cameras that are capable of capturing still images and video images.

It is common to encode video data from a video camera. Encoding the video data may be used to compress the video data so that the video data may be transmitted using less bandwidth and stored using less memory space.

One encoding technique developed by the Moving Picture Experts Group (MPEG) under the MPEG-4 Standard contemplates identifying media objects from a scene. These objects include a still object (e.g., a fixed background), a video object (e.g., a talking person without the background) and an audio object (e.g., the voice of the speaking person or background music). The distinguishing of media objects in MPEG-4 to describe a scene allows authors to construct scenes by placing media objects anywhere in a given coordinate system, applying transforms to change the geometrical or acoustical appearance of a media object, grouping primitive media objects to form compound media objects, applying streamed data to media objects to modify their attributes and changing viewing points.

Unfortunately, MPEG-4 and other object-based encoding techniques have shortfalls when handling moving objects. When an object moves appreciably within the scene or when the camera angle changes so that the object moves relative to the background, coding of the scene restarts (e.g., a new reference frame or “Iframe” is established upon which the encoding of future frames are based until another Iframe is established).

### SUMMARY

To improve video encoding, the present disclosure describes an improved video coding technique and system that employ object tracking and variable compression for different portions of the scene. The object is coded to have higher fidelity than a remainder of the scene. The higher fidelity facilitates tracking of the object that, in turn, assists in maintaining quality coding of the object.

According to one aspect of the disclosure, a method of coding a video signal that contains video data corresponding to an imaged scene includes identifying an object that corresponds to a visual element from the scene, a portion of the scene other than the visual element being a remainder of the scene; compressing video data corresponding to the object and compressing a remainder of the video data using an amount of compression that is greater than an amount of compression used to compress the video data for the object so as to produce a high fidelity video component corresponding to the visual element and a low fidelity video component corresponding to the remainder of the scene; and tracking the object using the high fidelity video component and using tracking information regarding a predicted position of the object in a future frame of the video signal to compress the video data when the future frame arrives.

According to one embodiment of the method, the object is identified using pattern recognition.

According to one embodiment of the method, the pattern recognition is used to identify a face of a person.

According to one embodiment of the method, the object is identified by proximity of the visual element to a predetermined location within the scene.

According to one embodiment of the method, the object is identified by receiving input from a user that specifies the visual element.

According to one embodiment of the method, the data is broken into blocks of pixels and blocks containing pixels corresponding to the object are compressed to generate the high fidelity video component and remaining blocks are compressed to generate the low fidelity video component.

According to one embodiment, the method further includes transmitting an output video signal that includes the high fidelity video component and low fidelity video component, and higher error coding is applied to the high fidelity video component than error coding that is applied to low fidelity video component.

According to one embodiment of the method, a reference frame is maintained for the object and a separate reference frame is maintained for the remainder of the scene.

According to one embodiment of the method, the video coding is carried out by an electronic device that includes a camera assembly that images the scene to generate the video signal.

According to one embodiment of the method, the electronic device is a mobile telephone.

According to another aspect of the disclosure, a video signal encoder that encodes a video signal that contains video data corresponding to an imaged scene includes an object identification module that identifies an object that corresponds to a visual element from the scene, a portion of the scene other than the visual element being a remainder of the scene; an image compression module that compresses video data corresponding to the object and compresses a remainder of the video data using an amount of compression that is greater than an amount of compression used to compress the video data for the object so as to produce a high fidelity video component corresponding to the visual element and a low fidelity video component corresponding to the remainder of the scene; and a motion tracking module that tracks the object using the high fidelity video component and generates tracking information regarding a predicted position of the object in a future frame of the video signal, the tracking information used by the image compression module to compress the video data when the future frame arrives.

According to one embodiment of the encoder, the object identification module uses pattern recognition to identify the object.

According to one embodiment of the encoder, the pattern recognition is used to identify a face of a person.

According to one embodiment of the encoder, the object identification module uses proximity of the visual element to a predetermined location within the scene to identify the object.

According to one embodiment of the encoder, the object identification module uses user input to identify the object.

According to one embodiment of the encoder, the video data is broken into blocks of pixels and blocks containing pixels corresponding to the object are compressed to generate the high fidelity video component and remaining blocks are compressed to generate the low fidelity video component.

According to one embodiment, the encoder further includes a transmission module to transmit an output video signal that includes the high fidelity video component and low fidelity video component to a destination, and the transmission module applies higher error coding to the high fidelity video component than error coding that the transmission module applies to the low fidelity video component.

According to one embodiment of the encoder, a reference frame is maintained for the object and a separate reference frame is maintained for the remainder of the scene.

According to one embodiment of the encoder, the encoder is part of an electronic device that includes a camera assembly that images the scene to generate the video.

According to one embodiment of the encoder, the electronic device is a mobile telephone and includes call circuitry to establish a call over a network.

According to another aspect of the disclosure, a second method of coding a video signal that contains video data corresponding to an imaged scene includes compressing video data corresponding to an identified portion of the scene; compressing a remainder of the video data using an amount of compression that is greater than an amount of compression used to compress the video data for the identified portion of the scene; and outputting a high fidelity video component corresponding to the identified portion of the scene and a low fidelity video component corresponding to the remainder of the video data.

According to one embodiment of the second method, the identified portion of the scene corresponds to a fixed region of a video image that is represented by the video signal.

These and further features will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the scope of the claims appended hereto.

Features that are described and/or illustrated with respect to one embodiment may be used in the same way or in a similar way in one or more other embodiments and/or in combination with or instead of the features of the other embodiments.

The terms “comprises” and “comprising,” when used in this specification, are taken to specify the presence of stated features, integers, steps or components but do not preclude the presence or addition of one or more other features, integers, steps, components or groups thereof.

### BRIEF DESCRIPTION OF THE DRAWINGS

FIGS. 1 and 2 are respectively a front view and a rear view of an exemplary electronic device that includes a representative camera assembly;

FIG. 3 is a schematic view of another representative camera assembly in the act of filming a scene;

FIG. 4 is a block diagram of a video encoder that may be used to encode video data in accordance with aspects of the disclosure;

FIG. 5 illustrates a representative video frame and depicts exemplary embodiments of identifying an object for tracking within an associated scene during video encoding;

FIG. 6 illustrates another representative video frame and depicts another exemplary embodiment of identifying an object for tracking within an associated scene during video encoding;

FIG. 7 illustrates a portion of a video frame that contains an object to be tracked and shows a manner in which compression may be applied to component pixel blocks from the portion of the video frame;

FIG. 8 is a schematic block diagram of the electronic device of FIGS. 1 and 2; and

FIG. 9 is a schematic diagram of a communications system in which the electronic device of FIGS. 1 and 2 may operate.

### DETAILED DESCRIPTION OF EMBODIMENTS

Embodiments will now be described with reference to the drawings, wherein like reference numerals are used to refer to like elements throughout. It will be understood that the figures are not necessarily to scale.

Described below in conjunction with the appended figures are various embodiments of an improved video coding system and method. In the illustrated embodiments, the video coding is carried out by a device that includes a video camera used to capture video data. It will be understood that the video data may be captured by one device and then transferred to another device that carries out the video coding. It also will be understood that the camera assembly may be capable of capturing still images in addition to video images.

The video coding will be primarily described in the context of processing video data generated by a digital video camera that is made part of a mobile telephone. It will be appreciated that the video coding may be used in other operational contexts such as, but not limited to, a dedicated video camera, another type of electronic device that has a camera (e.g., a personal digital assistant (PDA), a media player, a gaming device, a “web” camera, a computer, etc.), and so forth. Also, the video coding may be carried out by a device that processes existing video data, such as by a computer that accesses stored video data from a data storage medium or that receives video data over a communication link.

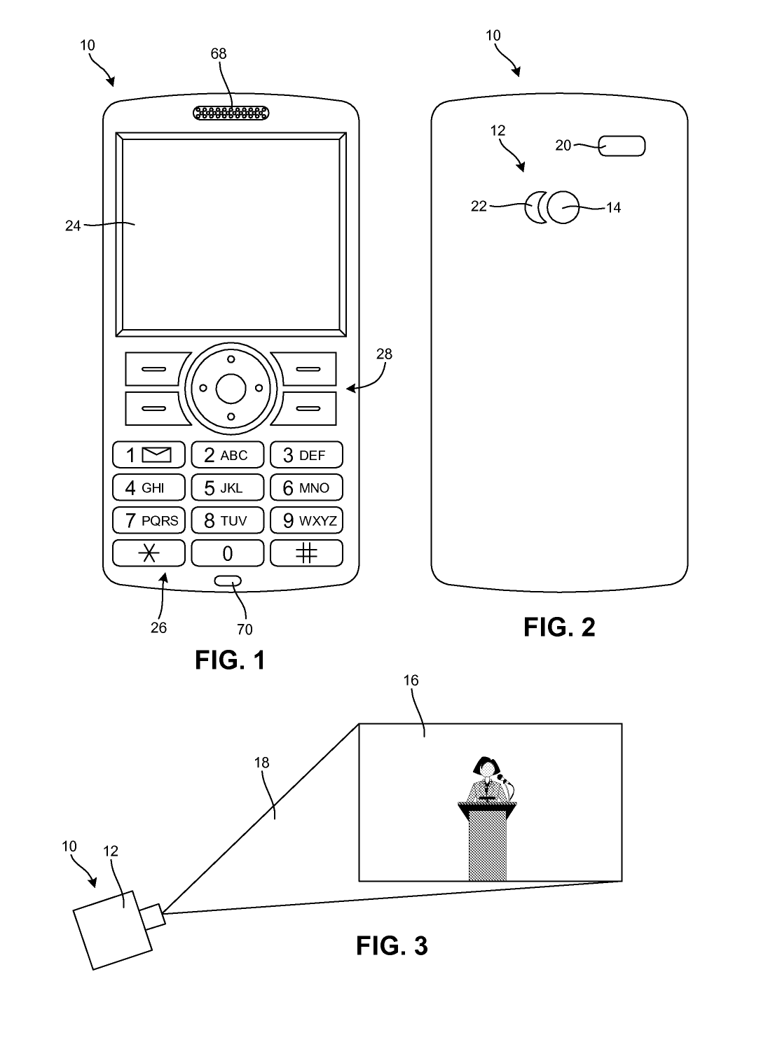

Referring initially to FIGS. 1 and 2, an electronic device 10 is shown. The illustrated electronic device 10 is a mobile telephone. The electronic device 10 includes a camera assembly 12 for taking digital still pictures and/or digital video clips. It is emphasized that the electronic device 10 need not be a mobile telephone, but could be a dedicated camera or some other device as indicated above. For instance, as illustrated in FIG. 3, the electronic device 10 is a dedicated camera assembly 12.

With reference to FIGS. 1 through 3, the camera assembly 12 may be arranged as a typical camera assembly that includes a lens assembly 14 to focus light from a scene 16 within the field of view 18 of the camera assembly 12 onto a sensor (not shown). The sensor converts the incident light into video data and outputs a corresponding video signal that may be coded using the techniques described in this disclosure.

The camera assembly 12 may include other components such as, but not limited to, optical elements that supplement the lens assembly (e.g., a protective window, a filter, a prism, a mirror), focusing mechanics, optical zooming mechanics, a flash or light source 20, a light meter 22, a display 24 for functioning as an electronic viewfinder and as part of an interactive user interface, a keypad 26 and/or buttons 28 for accepting user inputs, an optical viewfinder (not shown), a microphone, and any other components commonly associated with cameras. Another component may be an electronic controller that controls operation of the camera assembly 12. The electronic controller or a separate circuit (e.g., a dedicated video encoder) may carry out the video coding. The electrical assembly that carries out the video coding may be embodied, for example, as a processor that executes logical instructions that are stored by an associated memory, as firmware, as an arrangement of dedicated circuit components or as a combination of these embodiments. Thus, the video coding technique may be physically embodied as executable code (e.g., software) that is stored on a machine readable medium or as part of an electrical circuit.

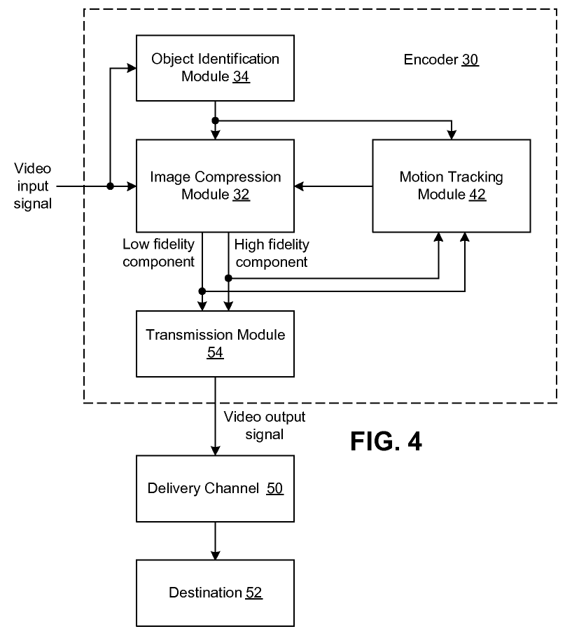

With additional reference to FIG. 4, illustrated is a block diagram of a video encoder 30. As indicated, the video encoder 30 may be implemented in hardware and/or in software. An image compression module 32 may receive an input video signal that contains video data to be encoded. For instance, the input video signal may be the video signal generated by the sensor of the camera assembly 12. The input video signal may be a series of frames (or video sequence) where each frame includes data to represent the imaged scene 16. Collectively, the series of frames are referred to as a video image. Exemplary frame rates for the input video signal may be 15 frames per second, 20 frames per second, 24 frames per second, 30 frames per second, or 60 frames per second.

The image compression module 32 applies a variable amount of compression to the video data for each frame of the video signal. For instance, the image compression module 32 may apply a low or moderate amount of compression to one region of the image and a higher amount of compression to the rest of the image. The portion of the image that is compressed by the lower amount will have higher image fidelity relative to the portion of the image that is compressed with a higher amount of compression. As such, a portion of the output video data corresponding to the portion of the video that is compressed with the lower amount of compression will be referred to as a high fidelity component and a portion of the output video data corresponding to the portion of video data that is compressed with the higher amount of compression will be referred to as a low fidelity component. The low fidelity component and the high fidelity component may be output by the image compression module 32 in a single, combined stream (e.g., one signal) or in separate data streams (e.g., two or more signals).

The portion of the image that receives lower compression may be a contiguous section of the image or may be non-contiguous. Therefore, the high fidelity component may correspond to one portion of the image or more than one portion of the image.

The portion(s) of the image to receive lower compression may be one or more visual elements from the image, and may be considered an object. For simplicity, the ensuing description will refer to an object in the singular, but the reader should understand that the description of an object in the singular explicitly includes one or more than one portions of the image.

The object may be identified by an object identification module 34. There are a number of ways in which the object may be identified by the object identification module 34. Some exemplary embodiments of object identification will be described. The object identification module 34 may be capable of identifying the object using just one technique or more than one technique. In embodiments where the object identification module 34 has the capability to identify the object using more than one technique, the technique that is employed for a video clip may be selected by a user. In another embodiment, the object identification module 34 may analyze the image and select one of the techniques based on results of the analysis.

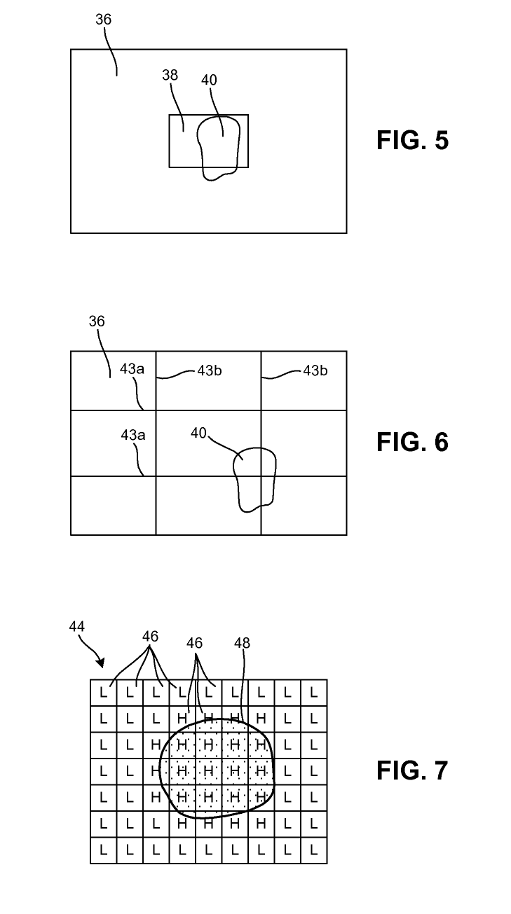

With additional reference to FIG. 5, a frame 36 from a series of frames that makes up a video image is shown. The frame 36 is a representation of a scene (e.g., the scene 16 of FIG. 3) at one moment in time. The scene may change over time as items in the scene (e.g., people, cars, animals, etc.) move and/or the camera assembly 12 moves with respect to the scene.

FIG. 5 is used to represent at least two exemplary techniques for object identification. The first technique is to designate a portion of the frame to receive lower compression than the rest of the frame. For instance, a fixed region 38 of the frame may be designated to receive lower compression. All visual elements inside the perimeter of fixed region 38 will then receive lower compression and a remainder of the image will then receive higher compression relative to the fixed region 38. In this embodiment, the object that is identified by the object identification module 34 is the fixed region 38 and the object will not change in relative location from frame to frame. In the illustrated embodiment, the fixed region 38 is illustrated as being in the center of the image and as a rectangle. It will be appreciated that the fixed region need not be in the center of the image and that other shapes (e.g., a circle or an oval) are contemplated. Also, the region 38 may surround a subregion (not illustrated) so that the subregion receives less compression than the region 38 that, in turn, receives less compression than the remainder of the image. In one embodiment, the fixed region 38 may be comprised of plural spatially distinct regions that are each designated to receive less compression than the remainder of the image. For instance, the fixed region 38 may be comprised of four regions arranged following the rule of thirds. The rule of thirds will be described in more detail with respect to FIG. 6. In another embodiment, the fixed region 38 may be specified by the user.

The use of a fixed region 38 of the image to be the identified object may be appropriate in certain filming circumstances. As an example, the fixed region 38 may be a convenient object if the user of the camera assembly 12 were to compose a video clip to concentrate on a stationary or moving item while keeping that item in a relatively constant location in the image. For instance, the user may set the camera assembly 12 to film a speaker who is expected to remain in a predicted location as shown in the exemplary scene 16 of FIG. 3. As another, the user may film a race car as the race car travels around a track and, during the filming, the user may attempt to center the car in the image.

As indicated, FIG. 5 may represent another technique for object identification. In this embodiment, the object is not a fixed region of the image, but is an item in the filmed scene that may move. The technique is implemented to identify an item that may be the user's main interest. In the illustrated embodiment, the object identification module 34 scans the image for predominate items that are located within or overlap with a designated area, such as the fixed region 38. In the representation of FIG. 5, an item 40 is present in the image and that item 40 may be singled out by the object identification module 34 as the identified object. The object identification module 34 may communicate the location of the identified object to the image compression module 32 such that the object may be compressed with less compression than the rest of the image. The location of the object may be specified in terms of a coordinate system, a group of pixel identities, or in any other appropriate manner.

When the object is identified as an item from the scene, the object may move in relative location and/or size from frame to frame. To track this movement, the encoder 30 may include a motion tracking module 42. The motion tracking module 42 may receive the object location information from the object identification module 34 so that the initial position and size of the object is known to the motion tracking module 42. Thereafter, the motion tracking module 42 may track location changes, shape changes and/or size changes of the object, which will be referred to collectively as the movement of the object. Object tracking information may be passed from the motion tracking module 42 to the image compression module 32 so that compression may be applied to the object even if the object has undergone movement. In this manner, the object is compressed to have relatively high fidelity throughout the video clip. Image compression and object tracking will be described in greater detail below.

FIG. 6 illustrates another technique of object identification. Similar to the second technique described with respect to FIG. 5, the technique is implemented to identify an item that may be the user's main interest. In the illustrated embodiment, the object identification module 34 scans the image for a prominent item or items that are coincident with designated points or spots, such as the points associated with the rule of thirds. The rule of thirds states that an image can be divided into nine equal parts by two equally-spaced horizontal lines 43a and two equally-spaced vertical lines 43b. The four points formed by the intersections of these lines can be used to align features in the video on the premise that an observer's eyes are naturally drawn toward these points. In FIG. 6, shown is a frame 36 from a series of frames that makes up a video image with points identified by the intersection of rule of thirds lines 43. In the illustrated embodiment, the object identification module 34 scans the image for predominate items that are located at the intersection of the lines 43. In the representation of FIG. 6, the item 40 is present at one of the intersections and item 40 may be singled out by the object identification module 34 as the identified object. The object identification module 34 may communicate the location of the identified object to the image compression module 32 and the motion tracking module 42.

Another technique for identifying the object is by user identification. In one embodiment, the display 24 that is used as an electronic viewfinder may be touch-sensitive to form a touchscreen. The user may touch a point on the touchscreen that corresponds to an item or items of highest interest to the user. In turn, the object identification module 34 may parse the image data for a visual element that is associated with the touched point and deem the part of the video data corresponding to the visual element as the object. The object identification module 34 may then communicate the location of the identified object to the image compression module 32 and the motion tracking module 42. In another embodiment, cross-hairs may be displayed on the display 24 with the image. The user may move the cross-hairs over a desired item using an input device, such as a navigation input device or a pointer, and select the item to be the object by pressing a select button. In turn, the object identification module 34 may parse the image data for a visual element that is associated with the selected point and deem the part of the video data corresponding to the visual element as the object. The object identification module 34 may then communicate the location of the identified object to the image compression module 32 and the motion tracking module 42.

Another technique for identifying the object is by pattern recognition. In this embodiment, the object identification module 34 may scan the image for items that are recognizable and likely to be the items of interest to the user. Recognizable items may include, for example, a person's face, a person's body (e.g., a humanoid form), a car, a truck, a cat, a dog and so forth. For instance, a common face recognition technique is to search an image for color patterns that are indicative of a pair of eyes together with a bridge of a nose. If plural items are recognized, each of those items may be identified as the object. If a scene contains a relatively large number of recognized items (e.g., three or more items), the items may be prioritized based on size and/or location within the scene and a selected number of the highest priority items (e.g., three or fewer) may be identified as the object.

With additional reference to FIG. 7, an exemplary technique for varying the amount of compression across the video image is illustrated. In FIG. 7, a portion of a video frame 44 is shown. The frame portion 44 is broken into a matrix of pixel blocks 46. Each pixel block 46 may be a group of pixels, such as an N×N square of pixels where N is a number, such as eight or sixteen. An object 48 to receive lower compression relative to the rest of the image is shown. The image compression module 32 applies low compression to the blocks 46 that overlap with the object 48 to result in high fidelity for those blocks 46. Hence, the high fidelity blocks are identified with an “H” in FIG. 7. Similarly, the image compression module 32 applies high compression to the blocks 46 that do not overlap with the object 48 to result in low fidelity for those blocks 46. Hence, the low fidelity blocks are identified with an “L” in FIG. 7. Compression techniques may include, for example, applying a discrete Fourier transform (DFT) to the video data for each block 46. Also, the compression techniques may include coding of residual data (sometimes referred to as “residuals”). Residual data relates to the parts of the image that move between frames.

The relative amounts of compression to produce the high fidelity component and the low fidelity component may correspond to user selection regarding operational performance or may be established by default. In another embodiment, the relative amounts of compression may be selected by the image compression module 32 based on one or more criteria. These criteria may include the quality (e.g., resolution) or other attributes of the input video signal, desired quality of the output signal, the type of delivery channel 50 that may be used to transmit the coded video data to a destination 52, the bit rate capacity of the delivery channel 50, a bit rate allocation scheme that allocates total available bit rate between the object and the remainder of the image, the quality or service (QoS) of the delivery channel 50, an amount of movement of the object relative to amount of movement of the remainder of the image, and so forth. In one embodiment, the higher compression to produce the low fidelity component may be carried out to retain four bits per color or six bits per color and the lower compression to produce the high fidelity component may be carried out to retain eight bits per color or ten bits per color. It will be appreciated that compression may be carried out to obtain other combinations of compression results.

In one embodiment, the same compression algorithm may be used to generate both the high and low fidelity components, but different settings and states may be used to generate the different fidelity components. In another embodiment, a first compression algorithm may be used to generate the high fidelity component and a second compression algorithm may be used to generate the low fidelity component.

In the illustration of FIG. 4, the low fidelity component and the high fidelity component are shown separately to visually portray aspects of the disclosure. While it is possible to output these components from the image compression module 32 in separate signals, it is also possible that the components may be output by the image compression module 32 together in a single, combined video data signal.

One or more operations may be performed on the output of the image compression module 32. For instance, the video data may be stored in a memory component for later retrieval and viewing and/or for later retrieval and transmission over a network to another device. In one embodiment, the encoder 30 may include an additional module that carries out post-processing of the video data to introduce video effects or perform other functions on the video data. Also, in the illustrated embodiment, the output of the image compression module 32 may be input to a transmission module 54. The transmission module 54 may prepare the video data for transmission to the destination 52 over the delivery channel 50. The delivery channel 50 may be any suitable network, wireless interface or wired interface. The transmission module 54 may be responsible for packetizing the video data for transmission in accordance with the protocol of the delivery channel 50.

In one embodiment, the transmission module 54 may apply a higher degree of error coding to the high fidelity component than to the low fidelity component. As will be appreciated, as the amount of error coding increases, the delivery performance of the associated packets increase. It is contemplated that the high fidelity component will have greater interest to the user (e.g., a viewer) at the destination 50 than the low fidelity component. Therefore, if the high fidelity component has higher error coding than the low fidelity component, then the delivery performance of the portion of the video image with the greater importance may be prioritized over the rest of the video image. This approach may maintain the overall quality of service associated with the delivery of the video image by not overloading the delivery channel 50 with a high degree of error coding for all the video data that is transmitted. Rather, the portion of the video data that is likely to be the most important part of the video image will be delivered with greater accuracy than the rest of the video data. Lost packets and other transmission issues will be more likely to occur with the lower priority portions of the video image. But missing data packets for such lower priority regions of the image may go unnoticed by the viewer or may not negatively affect the viewing experience.

As indicated above, the output of the image compression module 32 may be input to the motion tracking module 42. The motion tracking module 42 analyzes this video data to track changes in the size, the shape and the location of the object that was identified by the object identification module 34. The tracked changes may be used by the motion tracking module 42 to generate a prediction of the position of the object in the next frame or some future frame. The prediction may be input to the image compression module 32. The prediction may be updated on a frame by frame basis so that the image compression module 32 has a current prediction of the position of the tracked object. The current prediction may be used by the image compression module 32 to apply appropriate compression to an incoming frame of the video input signal. In particular, the portions of the frame corresponding to the predicted position of the object may receive the low compression and the remainder of the frame may receive the high compression. In this manner, the video data representation of the object may be maintained in the high fidelity component even as the location, shape and/or size of the object changes relative to the location, shape and/or size originally identified by the object identification module 34.

The motion tracking module 42 may employ a predictive analysis technique to track the movement of the object in terms of size, location and shape. For instance, the motion tracking module 42 may observe the object in a first frame (e.g., frame N) and identify the changes that occur to the object between the first frame and a second frame (e.g., frame N+1). Subspace tracking of basis vectors may be used to predict where the object will be in the future, such as a third frame (e.g., frame N+2) or subsequent frame. Residual data coded by the image compression module 32 also may be used to assist in the tracking function. The prediction as to position of the object in the future frame is the information that may be passed back to the image compression module 32 and, when the frame corresponding to the prediction arrives, the image compression module 32 may compress the portion of the frame corresponding to the prediction with less compression than the remainder of the frame.

The above-described technique for coding video data using variable compression and using motion tracking can lead to savings in the amount of space that it may take to store a video file for the video data. Similarly, if the video data were to be transmitted over the delivery channel 50, a savings in the amount of bit rate that it may take to transmit the data may be experienced. These savings are possible since a large portion of the video image (e.g., the portion of the image other than the object) may be compressed with relatively low fidelity. But the viewing clarity of the object may be maintained at a high level due to the application of a lower amount of compression to the object. As a result, the viewer may be satisfied with the overall image. The amount of compression applied to the majority of the image (e.g., everything but the object) may be less than the amount of compression used in prior art techniques where the entire image receives the same amount of compression. As a result, the net amount of video data output by the image compression module 32 using the disclosed technique may be lower than the net amount of video data that may be output by an encoder operating under conventional techniques. This may be especially true in circumstances where the object moves relative to a background, such when the object is a person that is walking or when the object is a car that is traveling around a race track. In these situations, prior art coding techniques are forced to start a reference frame (e.g., an Iframe) often as the background may be subject to a fairly rapid amount of change and the associated data output for the background component is very high compared to a stationary background. In one embodiment of the above-disclosed technique, as long as the object may be tracked, the compression may continue without starting a new reference frame. In another embodiment, separate reference frames may be maintained for the object and the remainder of the image as compression is separately applied to these respective portions of the image.

The video data that is output by the image compression module 32 may be decoded and used to drive a display so that the video content may be viewed. Since the object is coded to have higher fidelity than the rest of the image (e.g., the object may have greater resolution than the rest of the image), the object may appear clearer than the remainder of the image. Depending on the compression levels that are employed, the remainder portion of the image may appear to be slightly out of focus, at least relative to the object. In some situations, the appearance of the object versus the appearance of the remainder of the image may create a desired effect. For instance, the appearance differences may make the object appear to “stand out” from a background. It will be understood that the appearance differential between the object and the remainder portion of the image results from the separate compression that is applied to these segments of the image and not post-processing of the output of the image compression module 32. It is recognized, however, that any desired pre-processing of the video input signal and/or post-processing of the output of the image compression module 32 may be carried out.

Coding the object with higher fidelity affords substantial benefit to the tracking mechanism of the motion tracking module 42. On an area by area basis (e.g., a pixel square 46 by pixel square 46 basis), more bits of video data are allocated to the object than the remainder of the image. Since more information is present with respect to the object, the tracking mechanism may make a better prediction (e.g., estimate) about the future location, size and shape of the object than if the object had been coded with less fidelity. That is, the available spatial information about the object in the high fidelity component and tracking of how the constituent features move between frames will support a more accurate prediction of the where the object will be within the larger image in the next frame or some other future frame. In other words, the object is coded with a relatively large number of bits per color that, in effect, gives the object high resolution. This resolution provides a large amount of data that may be correlated in terms of pixels and motion vectors from frame to frame. Also, the tracking, which is a continuous process, may rely more on data that is coded with respect to the object than on data that is coded in residual frame data. In sum, the tracking mechanism should perform better using video data coded in the above-described manner than using video data that is coded in a conventional manner. These benefits perpetuate as the video image progresses through frames to maintain high quality coding of the object throughout the video clip, even though the object may be moving. This is because the emphasis is on initially coding the object using a relatively large number of bits and maintaining the fidelity of the object as it moves, while reducing the reliance on residual data relating to the object.

In one embodiment, the object identification module 34 may be configured to have a memory of previously tracked objects. For instance, if the encoder 30 tracks an object during one continuous recording of a scene (or a “take”), the object identification module 34 may search for that object in a later take. The closer the takes are to each other in time, the more probability there may be that the same object may be present in the subsequent take. Therefore, in one embodiment, the memory of previously tracked objects may have an associated time limit.

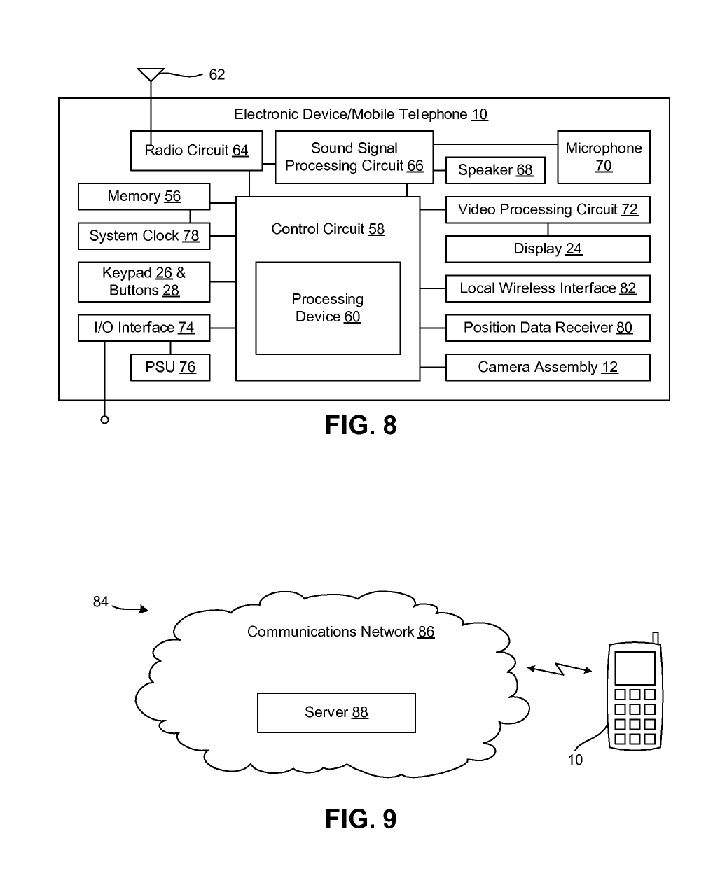

As indicated, the illustrated electronic device 10 shown in FIGS. 1 and 2 is a mobile telephone. Features of the electronic device 10, when implemented as a mobile telephone, will be described with additional reference to FIG. 8. The electronic device 10 is shown as having a “brick” or “block” form factor housing, but it will be appreciated that other housing types may be utilized, such as a “flip-open” form factor (e.g., a “clamshell” housing) or a slide-type form factor (e.g., a “slider” housing).

As indicated, the electronic device 10 may include the display 24. The display 24 displays information to a user such as operating state, time, telephone numbers, contact information, various menus, etc., that enable the user to utilize the various features of the electronic device 10. The display 24 also may be used to visually display content received by the electronic device 10 and/or retrieved from a memory 56 of the electronic device 10. The display 24 may be used to present images, video and other graphics to the user, such as photographs, mobile television content and video associated with games.

The keypad 26 and/or buttons 28 may provide for a variety of user input operations. For example, the keypad 26 may include alphanumeric keys for allowing entry of alphanumeric information such as telephone numbers, phone lists, contact information, notes, text, etc. In addition, the keypad 26 and/or buttons 28 may include special function keys such as a “call send” key for initiating or answering a call, and a “call end” key for ending or “hanging up” a call. Special function keys also may include menu navigation and select keys to facilitate navigating through a menu displayed on the display 24. For instance, a pointing device and/or navigation keys may be present to accept directional inputs from a user. Special function keys may include audiovisual content playback keys to start, stop and pause playback, skip or repeat tracks, and so forth. Other keys associated with the mobile telephone may include a volume key, an audio mute key, an on/off power key, a web browser launch key, etc. Keys or key-like functionality also may be embodied as a touch screen associated with the display 24. Also, the display 24 and keypad 26 and/or buttons 28 may be used in conjunction with one another to implement soft key functionality. As such, the display 24, the keypad 26 and/or the buttons 28 may be used to control the camera assembly 12.

The electronic device 10 may include call circuitry that enables the electronic device 10 to establish a call and/or exchange signals with a called/calling device, which typically may be another mobile telephone or landline telephone. However, the called/calling device need not be another telephone, but may be some other device such as an Internet web server, content providing server, etc. Calls may take any suitable form. For example, the call could be a conventional call that is established over a cellular circuit-switched network or a voice over Internet Protocol (VoIP) call that is established over a packet-switched capability of a cellular network or over an alternative packet-switched network, such as WiFi (e.g., a network based on the IEEE 802.11 standard), WiMax (e.g., a network based on the IEEE 802.16 standard), etc. Another example includes a video enabled call that is established over a cellular or alternative network.

The electronic device 10 may be configured to transmit, receive and/or process data, such as text messages, instant messages, electronic mail messages, multimedia messages, image files, video files, audio files, ring tones, streaming audio, streaming video, data feeds (including podcasts and really simple syndication (RSS) data feeds), and so forth. It is noted that a text message is commonly referred to by some as “an SMS,” which stands for simple message service. SMS is a typical standard for exchanging text messages. Similarly, a multimedia message is commonly referred to by some as “an MMS,” which stands for multimedia message service. MMS is a typical standard for exchanging multimedia messages. Processing data may include storing the data in the memory 56, executing applications to allow user interaction with the data, displaying video and/or image content associated with the data, outputting audio sounds associated with the data, and so forth.

The electronic device 10 may include a primary control circuit 58 that is configured to carry out overall control of the functions and operations of the electronic device 10. The control circuit 58 may be responsible for controlling the camera assembly 12, including the tasks of the encoder 30. Alternatively, the encoder 30 may be embodied by a separate controller (not shown) of the camera assembly 12.

The control circuit 58 may include a processing device 60, such as a central processing unit (CPU), microcontroller or microprocessor. The processing device 60 may execute code that implements the various functions of the electronic device 10. The code may be stored in a memory (not shown) within the control circuit 58 and/or in a separate memory, such as the memory 56, in order to carry out operation of the electronic device 10. It will be apparent to a person having ordinary skill in the art of computer programming, and specifically in application programming for mobile telephones or other electronic devices, how to program a electronic device 10 to operate and carry out various logical functions.

Among other data storage responsibilities, the memory 56 may be used to store photographs and/or video clips that are captured by the camera assembly 12. Alternatively, the images may be stored in a separate memory. The memory 56 may be, for example, one or more of a buffer, a flash memory, a hard drive, a removable media, a volatile memory, a non-volatile memory, a random access memory (RAM), or other suitable device. In a typical arrangement, the memory 56 may include a non-volatile memory (e.g., a NAND or NOR architecture flash memory) for long term data storage and a volatile memory that functions as system memory for the control circuit 58. The volatile memory may be a RAM implemented with synchronous dynamic random access memory (SDRAM), for example. The memory 56 may exchange data with the control circuit 58 over a data bus. Accompanying control lines and an address bus between the memory 56 and the control circuit 58 also may be present.

Continuing to refer to FIGS. 1, 2, and 8, the electronic device 10 includes an antenna 62 coupled to a radio circuit 64. The radio circuit 64 includes a radio frequency transmitter and receiver for transmitting and receiving signals via the antenna 62. The radio circuit 64 may be configured to operate in a mobile communications system and may be used to send and receive data and/or audiovisual content. Receiver types for interaction with a mobile radio network and/or broadcasting network include, but are not limited to, global system for mobile communications (GSM), code division multiple access (CDMA), wideband CDMA (WCDMA), general packet radio service (GPRS), WiFi, WiMax, digital video broadcasting-handheld (DVB-H), integrated services digital broadcasting (ISDB), etc., as well as advanced versions of these standards. It will be appreciated that the antenna 62 and the radio circuit 64 may represent one or more than one radio transceivers.

The electronic device 10 further includes a sound signal processing circuit 66 for processing audio signals transmitted by and received from the radio circuit 64. Coupled to the sound processing circuit 66 are a speaker 68 and a microphone 70 that enable a user to listen and speak via the electronic device 10 as is conventional. The radio circuit 64 and sound processing circuit 66 are each coupled to the control circuit 58 so as to carry out overall operation. Audio data may be passed from the control circuit 58 to the sound signal processing circuit 66 for playback to the user. The audio data may include, for example, audio data from an audio file stored by the memory 56 and retrieved by the control circuit 58, or received audio data such as in the form of streaming audio data from a mobile radio service. The sound processing circuit 66 may include any appropriate buffers, decoders, amplifiers and so forth.

The display 24 may be coupled to the control circuit 58 by a video processing circuit 72 that converts video data to a video signal used to drive the display 24. The video processing circuit 72 may include any appropriate buffers, decoders, video data processors and so forth. The video data may be generated by the control circuit 58, retrieved from a video file that is stored in the memory 56, derived from an incoming video data stream that is received by the radio circuit 64 or obtained by any other suitable method. Also, the video data may be generated by the camera assembly 12 and coded by the encoder 30.

The electronic device 10 may further include one or more I/O interface(s) 74. The I/O interface(s) 74 may be in the form of typical mobile telephone I/O interfaces and may include one or more electrical connectors. As is typical, the I/O interface(s) 74 may be used to couple the electronic device 10 to a battery charger to charge a battery of a power supply unit (PSU) 76 within the electronic device 10. In addition, or in the alternative, the I/O interface(s) 74 may serve to connect the electronic device 10 to a headset assembly (e.g., a personal handsfree (PHF) device) that has a wired interface with the electronic device 10. Further, the I/O interface(s) 74 may serve to connect the electronic device 10 to a personal computer or other device via a data cable for the exchange of data. The electronic device 10 may receive operating power via the I/O interface(s) 74 when connected to a vehicle power adapter or an electricity outlet power adapter. The PSU 76 may supply power to operate the electronic device 10 in the absence of an external power source.

The electronic device 10 also may include a system clock 78 for clocking the various components of the electronic device 10, such as the control circuit 58 and the memory 56.

The electronic device 10 also may include a position data receiver 80, such as a global positioning system (GPS) receiver, Galileo satellite system receiver or the like. The position data receiver 80 may be involved in determining the location of the electronic device 10.

The electronic device 10 also may include a local wireless interface 82, such as an infrared transceiver and/or an RF interface (e.g., a Bluetooth interface), for establishing communication with an accessory, another mobile radio terminal, a computer or another device. For example, the local wireless interface 82 may operatively couple the electronic device 10 to a headset assembly (e.g., a PHF device) in an embodiment where the headset assembly has a corresponding wireless interface.

With additional reference to FIG. 9, the electronic device 10 may be configured to operate as part of a communications system 84. The system 84 may include a communications network 86 having a server 88 (or servers) for managing calls placed by and destined to the electronic device 10, transmitting data to the electronic device 10 and carrying out any other support functions. The server 88 communicates with the electronic device 10 via a transmission medium. The transmission medium may be any appropriate device or assembly, including, for example, a communications tower (e.g., a cell tower), another mobile telephone, a wireless access point, a satellite, etc. Portions of the network may include wireless transmission pathways. The network 86 may support the communications activity of multiple electronic devices 10 and other types of end user devices. As will be appreciated, the server 88 may be configured as a typical computer system used to carry out server functions and may include a processor configured to execute software containing logical instructions that embody the functions of the server 88 and a memory to store such software.

Although certain embodiments have been shown and described, it is understood that equivalents and modifications falling within the scope of the appended claims will occur to others who are skilled in the art upon the reading and understanding of this specification.

What is claimed is:

1. A method of coding a video signal that contains video data corresponding to an imaged scene, comprising:
identifying an object that corresponds to a visual element from the scene, a portion of the scene other than the visual element being a remainder of the scene;
compressing video data corresponding to the object and compressing a remainder of the video data using an amount of compression that is greater than an amount of compression used to compress the video data for the object so as to produce a high fidelity video component corresponding to the visual element and a low fidelity video component corresponding to the remainder of the scene; and
tracking the object using the high fidelity video component and using tracking information regarding a predicted position of the object in a future frame of the video signal to compress the video data when the future frame arrives.

2. The method of claim 1, wherein the object is identified using pattern recognition.

3. The method of claim 2, wherein the pattern recognition is used to identify a face of a person.

4. The method of claim 1, wherein the object is identified by proximity of the visual element to a predetermined location within the scene.

5. The method of claim 1, wherein the object is identified by receiving input from a user that specifies the visual element.

6. The method of claim 1, wherein the data is broken into blocks of pixels and blocks containing pixels corresponding to the object are compressed to generate the high fidelity video component and remaining blocks are compressed to generate the low fidelity video component.

7. The method of claim 1, further comprising transmitting an output video signal that includes the high fidelity video component and low fidelity video component, and wherein higher error coding is applied to the high fidelity video component than error coding that is applied to low fidelity video component.

8. The method of claim 1, wherein a reference frame is maintained for the object and a separate reference frame is maintained for the remainder of the scene.

9. The method of claim 1, wherein the video coding is carried out by an electronic device that includes a camera assembly that images the scene to generate the video signal.

10. The method of claim 9, wherein the electronic device is a mobile telephone.

11. A video signal encoder that encodes a video signal that contains video data corresponding to an imaged scene, comprising:
an object identification module that identifies an object that corresponds to a visual element from the scene, a portion of the scene other than the visual element being a remainder of the scene;
an image compression module that compresses video data corresponding to the object and compresses a remainder of the video data using an amount of compression that is greater than an amount of compression used to compress the video data for the object so as to produce a high fidelity video component corresponding to the visual element and a low fidelity video component corresponding to the remainder of the scene; and
a motion tracking module that tracks the object using the high fidelity video component and generates tracking information regarding a predicted position of the object in a future frame of the video signal, the tracking information used by the image compression module to compress the video data when the future frame arrives.

12. The encoder of claim 11, wherein the object identification module uses pattern recognition to identify the object.

13. The encoder of claim 12, wherein the pattern recognition is used to identify a face of a person.

14. The encoder of claim 11, wherein the object identification module uses proximity of the visual element to a predetermined location within the scene to identify the object.

15. The encoder of claim 11, wherein the object identification module uses user input to identify the object.

16. The encoder of claim 11, wherein the video data is broken into blocks of pixels and blocks containing pixels corresponding to the object are compressed to generate the high fidelity video component and remaining blocks are compressed to generate the low fidelity video component.

17. The encoder of claim 11, further comprising a transmission module to transmit an output video signal that includes the high fidelity video component and low fidelity video component to a destination, wherein the transmission module applies higher error coding to the high fidelity video component than error coding that the transmission module applies to the low fidelity video component.

18. The encoder of claim 11, wherein a reference frame is maintained for the object and a separate reference frame is maintained for the remainder of the scene.

19. The encoder of claim 11, wherein the encoder is part of an electronic device that includes a camera assembly that images the scene to generate the video.

20. The encoder of claim 19, wherein the electronic device is a mobile telephone and includes call circuitry to establish a call over a network.

21. A method of coding a video signal that contains video data corresponding to an imaged scene, comprising:
compressing video data corresponding to an identified portion of the scene;
compressing a remainder of the video data using an amount of compression that is greater than an amount of compression used to compress the video data for the identified portion of the scene; and
outputting a high fidelity video component corresponding to the identified portion of the scene and a low fidelity video component corresponding to the remainder of the video data.

22. The method of claim 21, wherein the identified portion of the scene corresponds to a fixed region of a video image that is represented by the video signal.
